(19) United States
(12) Patent Application Publication
(10) Pub. No.: US 2015/0055813 A1
(43) Pub. Date: Feb. 26, 2015

(54) WEARABLE MALLEABLE EARPHONE CASE

(71) Applicant: Lorie Ingraham, Orlando, FL (US)

(72) Inventor: Lorie Ingraham, Orlando, FL (US)

(21) Appl. No.: 14/466,068

(22) Filed: Aug. 22, 2014

Related U.S. Application Data
(60) Provisional application No. 61/868,358, filed on Aug. 21, 2013.

(51) Int. Cl. H04R 1/02; H04R 1/06; H04R 1/10

(52) U.S. Cl. CPC H04R 1/02; H04R 1/1033; H04R 1/06
USPC 381/370

(57) ABSTRACT

A wearable malleable earphone case includes a main body having a front surface, back surface, bottom surface and a pair of opposing side surfaces forming a generally hollow interior space. A lid is hingedly secured along the top surface of the main body, and an elongated central post is positioned within the main body. A plurality of apertures function to receive a set of earphones and the central post secures the earphone cord within the device.

### CROSS-REFERENCE TO RELATED APPLICATIONS

This application claims the benefit of U.S. application Ser. No. 61/868,358 filed on Aug. 21, 2013, the contents of which are incorporated herein by reference.

### TECHNICAL FIELD

The present invention relates generally to wearable audio earphone storage cases, and more specifically, to a malleable, clip-on audio earphone case that can be easily worn by a user, and functions to organize and protect the earphones from damage while they are being used.

### BACKGROUND

Owing to the popularity of small media devices such as MP3 players, smartphones, portable DVD systems, tablet PC's and the like, many people use earphones on a daily basis. One of the most common tasks which often incorporates the use of earphones is athletic activities such as running, cycling, boating and/or strength training, for example.

Regardless of the task, whenever the earphones are being used, the jack portion is connected to the portable device, and the speaker portion(s) are in communication with the users ears. However, the excess wire between the two ends is left to hang, and often times will become entangled in the users clothing and/or onto other articles during strenuous activities. When this occurs, the speaker portions can be painfully ripped from the users ear, or the jack portion can cause damage to the device speaker jack.

Although there are several known types and forms of earphone cases on the market which function to store earphones when they are not in use, there remains a need for an improved earphone case which can be worn by a user, and can function to protect the earphones at all times, in order to avoid the above described issues.

### SUMMARY OF THE INVENTION

The present invention is directed to a wearable malleable earphone case.

One embodiment of the present invention can include a main body having a front surface, back surface, bottom surface and a pair of opposing side surfaces forming a generally hollow interior space. A lid can be positioned along the top surface of the main body, and an elongated central post can be positioned within the main body. A plurality of apertures function to receive a set of earphones and the central post secures the earphone cord within the device.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows a front view of the wearable malleable earphone case in a closed position, in accordance with one embodiment of the invention.

FIG. 2 shows a perspective view of the wearable malleable earphone case in a closed position, in accordance with another embodiment of the invention.

FIG. 3 shows a perspective view of the wearable malleable earphone case in an open position, in accordance with one embodiment of the invention.

FIG. 4 is another perspective view of the wearable malleable earphone case in an open position, in accordance with one embodiment of the invention.

FIG. 5 shows a front view of the wearable malleable earphone case in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

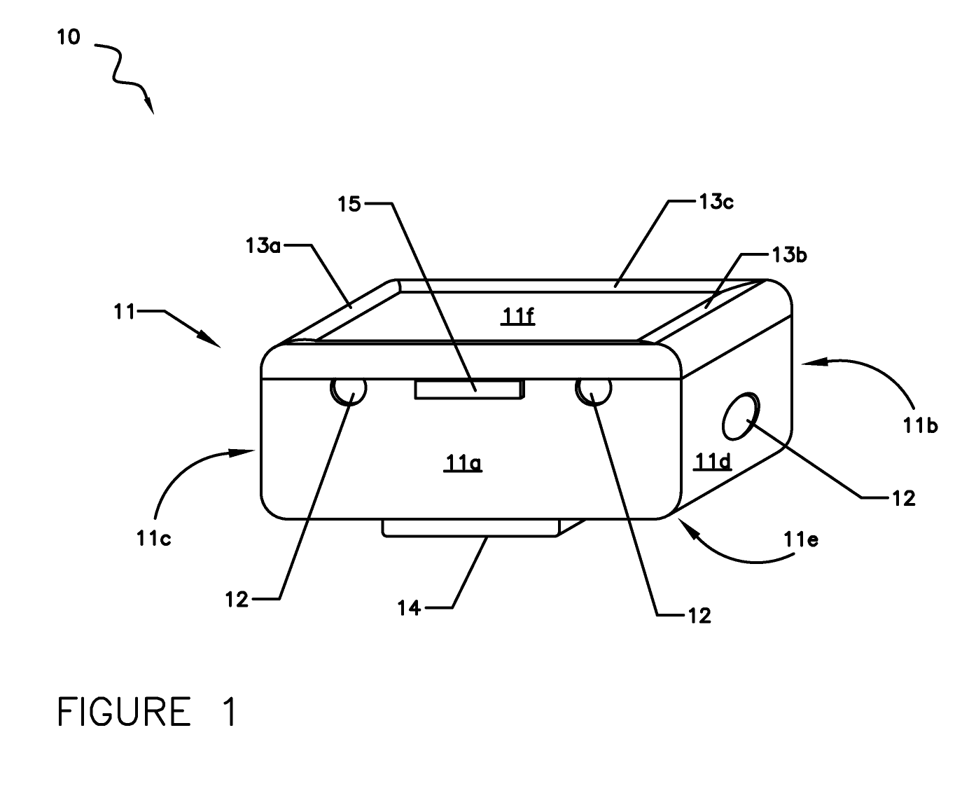

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

Although described throughout this document as “earphones” shall refer to any type and form of portable wired speakers, also referred to as headphones, earbuds and the like. Additionally, the term “indicia” can include, without limitation, any type of decorative elements such as colors, markings, words, shapes, symbols, logos, designs, types of materials, lights and images, for example.

FIG. 1 illustrates one embodiment of a wearable malleable earphone case 10 that is useful for understanding the inventive concepts disclosed herein. As shown, the device 10 can include a generally box-like main body 11 having a front end 11a, a back end 11b, a left-side 11c, a right-side 11d, and a bottom end 11e forming a generally cavernous interior space. A lid 11f is secured to the back end 11b via a hinge 17, and functions to transition the box between an open and closed configuration via a locking nub 15.

In one preferred embodiment the main body 11 can include a generally rectangular shape and can be constructed from a malleable plastic and/or rubber material, and the hinge 17 can preferably include a living hinge. However, any number of other shapes, sizes and materials may be used, such as metal, leather, cardboard, textile or straw, for example. In the preferred embodiment, the main body can be flexible and lightweight so that it can be clipped onto an armband or a user's clothing during when running, cycling or during other strenuous activities.

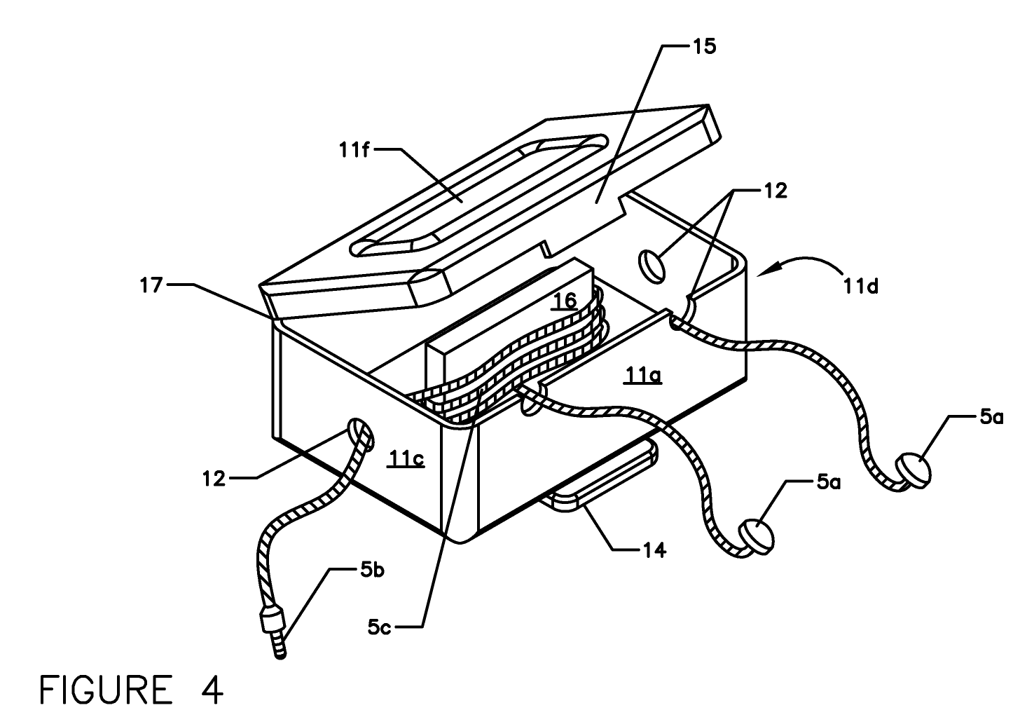

As shown, the main body can also include a plurality of apertures 12. In one embodiment, the front end 11a can include two spaced apertures 12 which can be used to allow the wires from the earbuds to pass through to the inside of the box (See FIG. 4) Likewise, each of the side surfaces 11c and 11d can also include apertures 12 in order to accommodate the earphone jack plug (See also FIG. 4). Of course, any number of other apertures can also be located along any other portions of the main body and/or lid.

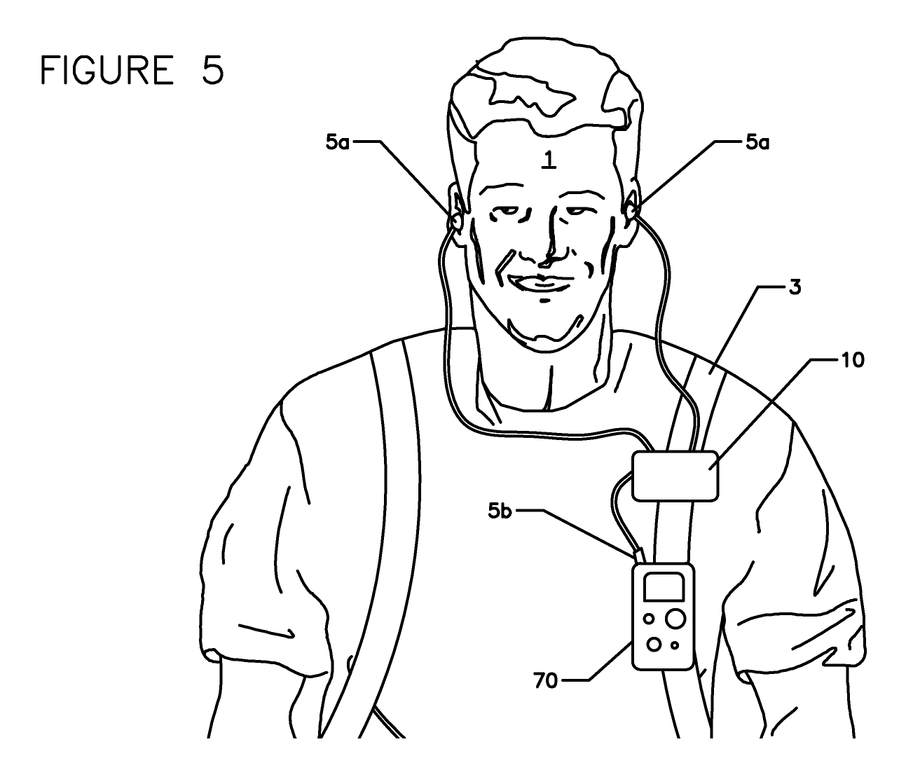

In another embodiment, the top surface of the lid 11f can further include overhanging edges 13a-13c which can function to allow a user to secure personalized item, such as a photograph, for example, onto the top surface of the device. Likewise, a clip 14 can be disposed along the bottom surface of the main body 11e, and can function to secure the device onto the clothing of a user (See FIG. 5)

Although dimensions are not critical, in one embodiment, the device 10 can include a length (measured between the side walls 11c and 11d) of approximately three inches, a height (measured between bottom wall 11e and lid 11f) of approximately 1.5 inches, and a width (measured from front to back surfaces 11a-11b) of approximately 1.75 inches. Of course, those of skill in the art will recognize that the other embodiments having different shapes and sizes are also contemplated.

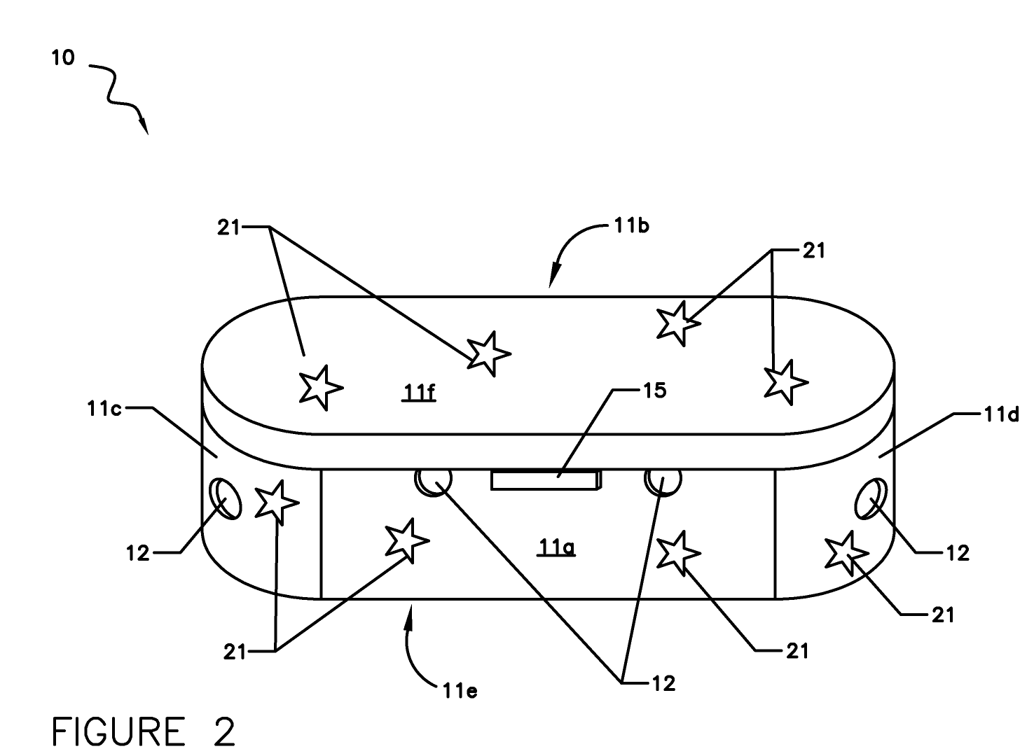

Although described above as including a generally rectangular shape, the invention is not so limiting, in this regard, FIG. 2 illustrates another embodiment wherein the main body includes a generally oval shaped member, having indicia 21 displayed thereon.

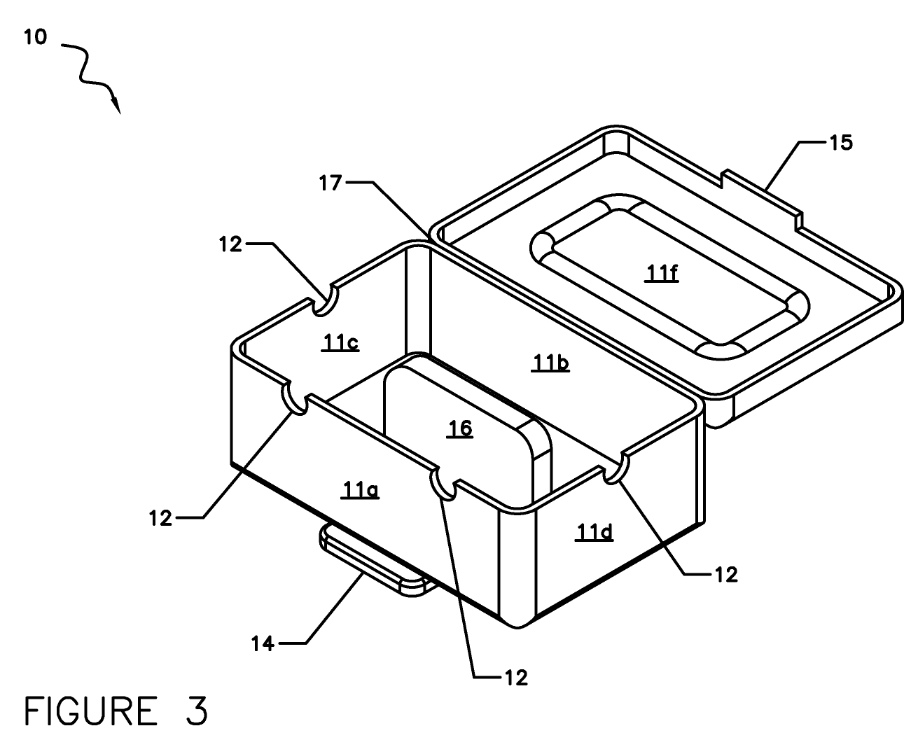

As shown in FIG. 3, the interior of the main body can include an elongated post 16 that is centrally located and extending upward from the bottom wall 11e. The post 16 is secured along the center of the main body where it is the easiest and most efficient for receiving the earphone wires and allowing room for the earbuds and jack to be stored inside of the box. Such positioning also functions to allow the walls of the box to bend without causing damage to the central post 16 and/or the inserted earphones.

As shown in FIG. 4, the two apertures 12 located along the front surface of the main body 11a can function to allow the earbud speakers 5a to be accessible to the user. Likewise, the apertures 12 located on either side of the main body can function to allow the earbud jack 5b to be accessible to the portable media player. Finally, the middle portion of the earbud cord 5c can be wrapped around the post 16 in a winding pattern, where they will be protected against being snagged on clothing or other objects while the device is in use. This method of wrapping the cord around in one direction on a central post 16 is more simple for children and adults to use, than other methods previously used to manage earphone cords.

FIG. 5 illustrates one embodiment of the box 10 in operation. The box 10 is shown clipped onto a strap 3 of a backpack worn by a person 1. The speaker portion 5a of the earbuds protrude from the holes in the front of the device and are in communication with the persons ears. The earphone jack plug 5b is shown plugged into a portable audio device 70, and the middle portion of the earbud cord 5c is secured within the box 10 so as to prevent it from interfering with activities by the user. In this regard, by wrapping the earbud cord around the post, and having a closed the lid, the device has a double layer of protection against the cord becoming loose and interfering with the activities of a user.

Although described with regard to specific shapes, sizes, materials, indicia and uses, this is for illustrative purposes only, as the above described product is not to be construed as limiting in any way. To this end, many variations, derivations and adjustments may be made to one or more of the above described embodiments without undue experimentation, and shall still maintain the scope and spirit of the inventive concepts disclosed herein.

As described herein, one or more elements of the wearable malleable earphone case 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the main body portions 11a-11f, the clip 14 and the central post 16 for example, may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A wearable malleable earphone case, comprising:
a main body having a front surface, back surface, bottom surface and a pair of opposing side surfaces forming a generally hollow interior space;
a lid that is hingedly disposed along the back surface, said lid being configured to transition between an open configuration and a closed configuration; and
a plurality of apertures that are disposed along the main body, each of said apertures being configured to receive at least one of an earphone speaker, an earphone jack, and an earphone cable.

2. The device of claim 1, further comprising:
an elongated post that is disposed along the central portion of the bottom surface and disposed within the generally hollow interior space, said post being configured to receive an earphone wire via a coiling motion.

3. The device of claim 1, further comprising:
a clip that is located along an outside facing portion of the bottom surface, said clip being configured to secure the device onto a secondary object.

4. The device of claim 1, wherein the main body is constructed from a single piece of malleable material, and is configured to bend while in use.

5. The device of claim 1, wherein the main body includes a generally rectangular shape.

6. The device of claim 1, wherein the main body includes a generally oval shape.

7. The device of claim 1, further comprising a locking nub that is configured to maintain the device in the closed configuration.

8. The device of claim 1, further comprising a plurality of edges that are disposed along an outside facing portion of the upper surface, said edges being configured to receive and retain a personalized item.
